(19) United States
(12) Patent Application Publication
(10) Pub. No.: US 2025/0289289 A1
(43) Pub. Date: Sep. 18, 2025

(54) PASSENGER CAR MULTI-SYSTEM INTEGRATION

(71) Applicants: Mastery Tech (Hong Kong) Limited, Kowloon KLN (HK); Mastery Tech (Anhui) Limited, Kowloon KLN (HK)

(72) Inventors: Jianjun Tan, Kowloon KLN (HK); Daisy Lina Kwok, Kowloon KLN (HK)

(21) Appl. No.: 19/080,095

(22) Filed: Mar. 14, 2025

Related U.S. Application Data
(60) Provisional application No. 63/565,254, filed on Mar. 14, 2024.

(51) Int. Cl. B60H 1/22; B60S 1/48; B60S 1/54; B60S 1/56

(52) U.S. Cl. CPC B60H 1/22; B60S 1/488; B60S 1/54; B60S 1/56; B60H 2001/2271

(57) ABSTRACT

A passenger car multi-system integration system includes at least an air compressor and a liquid tank. The air compressor and the liquid tank have exterior walls that at least partially contact. During operation of the air compressor, heat as a byproduct is transferred from the air compressor to the liquid tank by conduction, and is then transferred to the contents of the liquid tank by convection. The passenger car multi-system may also include at least one electromagnetic clutch in communication with the motor and the air compressor or the motor and a water pump, such that power can be optionally directed to the air compressor or the water pump during operation of the motor.

### PRIORITY CLAIM

This application claims priority to and the benefit of U.S. Provisional Patent Application Ser. No. 63/565,254, filed Mar. 14, 2024, the entire disclosure of which is hereby incorporated by reference.

### TECHNICAL FIELD

This disclosure relates generally to pneumatic, hydraulic, and electronic sensor systems for modern passenger vehicles.

### BACKGROUND

Modern passenger vehicles typically include a host of pneumatic, hydraulic, and electronic systems, each independent of the others. For example, a typical modern passenger vehicle has a pneumatic suspension system that relies on compressed air, a hydraulic braking system that relies on the compression of water or braking fluid, and an electronic sensor array that facilitates the use of adaptive cruise control or lane assistance technology. One or more of the sensors in the electronic sensor array can become blocked by dirt and grime from the road and environment. These systems do not communicate with each other and operate independently both electronically and in physical space.

This independent operation is inefficient because the air compressor used for the pneumatic systems creates heat that is dissipated to the environment, while a liquid tank may rely on a separate heating system to make sure that the fluid inside does not freeze, especially in cold weather. Likewise, the electronic sensors that many cars have today for lane assist technology and other safety technologies may malfunction if they get too dirty or if frost blocks the sensing portion. The independent operation of these separate vehicular systems wastes gas and electric power in the car, necessitates the use of more raw material in manufacturing by having redundancy between systems of the same nature (such as having two pneumatic systems that rely on separate air compressors rather than sharing a single air compressor), causes the passenger car to be heavier than it otherwise could be (further wasting money in the form of reduced gas mileage and creating unnecessary emissions), makes the passenger car more complex than is necessary, and can cause electronic sensors to malfunction for an unnecessary amount of time, exposing users to increased levels of danger from driving.

### SUMMARY

The present disclosure provides new and innovative systems, methods, and apparatuses for the use of pneumatic, hydraulic, and electronic sensor systems for passenger vehicles to promote efficiency. More specifically, the present disclosure provides an integrated way of arranging the pneumatic, hydraulic, and electronic sensor components of a passenger vehicle such that heat and other energy produced by one component, which would otherwise be lost to the environment, is used to aid in the efficient operation of the other components, as well as expanding the use of certain components to aid others. It should be appreciated that the systems, methods, and apparatuses herein are not limited to passenger vehicles, but can be used on any system that utilizes compressed air tanks, liquid tanks, and, optionally, electronic sensors.

In light of the disclosure set forth herein, and without limiting the disclosure in any way, in a first aspect, which may be combined with any other aspect described herein, or portion thereof, a passenger car multi-system integration system includes an air compressor comprising an air compressor exterior wall, and a pump, and a liquid tank comprising a liquid tank exterior wall that is configured to at least a partially contact the air compressor exterior wall, an internal wall which forms a fluid vessel, and at least one fluid, wherein the air compressor and the liquid tank are configured such that when the pump operates, it expels energy in the form of heat as a byproduct, causing the air compressor exterior wall to rise in temperature, and wherein heat exchange is achieved between the partially contacting portions of the air compressor and liquid tank by conduction, raising the temperature of the internal wall of the liquid tank by conduction, and wherein heat exchange is then achieved between the internal wall of the liquid tank and the at least one fluid by way of convection, creating thermal communication between the pump and the at least one fluid.

In a second aspect of the present disclosure, which may be combined with any other aspect described herein, or portion thereof, the passenger car multi-system integration system further includes an electronic sensor, and a cleaning system comprising at least one nozzle in pneumatic communication with the air compressor or in hydraulic communication with the liquid tank, the at least one nozzle configured such that the expulsion of gas or liquid from the nozzle causes contact between the gas or liquid and the electronic sensor.

In a third aspect of the present disclosure, which may be combined with any other aspect described herein, or portion thereof, gas which has been heated by the operation of the air compressor is expelled from the nozzle.

In a fourth aspect of the present disclosure, which may be combined with any other aspect described herein, or portion thereof, liquid which has been heated by the operation of the air compressor in thermal communication with the liquid tank is expelled from the nozzle.

In a fifth aspect of the present disclosure, which may be combined with any other aspect described herein, or portion thereof, the passenger car multi-system integration further includes a resistance wire.

In a sixth aspect of the present disclosure, which may be combined with any other aspect described herein, or portion thereof, the resistance wire is a chip resistor.

In a seventh aspect of the present disclosure, which may be combined with any other aspect described herein, or portion thereof, the resistance wire is configured between the nozzle and the electronic sensor such that any gas or liquid expelled from the nozzle comes in contact with the resistance wire.

In an eighth aspect of the present disclosure, which may be combined with any other aspect described herein, or portion thereof, the resistance wire is in thermal communication with the electronic sensor.

In a ninth aspect of the present disclosure, which may be combined with any other aspect described herein, or portion thereof, a passenger car multi-system integration system includes an air compressor, a liquid tank, a water pump in hydraulic communication with the liquid tank, a motor, a first electromagnetic clutch which is in mechanical communication with the motor and the air compressor, and a second electromagnetic clutch which is in mechanical communication with the motor and the water pump.

In a tenth aspect of the present disclosure, which may be combined with any other aspect described herein, or portion thereof, the first electromagnetic clutch is able to engage independently of the second electromagnetic clutch and the second electromagnetic clutch is able to engage independently of the first electromagnetic clutch, such that power is able to be independently translated from the motor to either the air compressor or the water pump, or both.

In an eleventh aspect of the present disclosure, which may be combined with any other aspect described herein, or portion thereof, a passenger car multi-system integration system comprises an air compressor comprising an air compressor exterior wall, a compression motor, and a pump, and a liquid tank comprising a liquid tank exterior wall that is configured to at least a partially contact the air compressor exterior wall, an internal wall which forms a fluid vessel, and at least one fluid, wherein the air compressor and the liquid tank are configured such that when the pump operates, it expels energy in the form of heat as a byproduct, causing the air compressor exterior wall to rise in temperature, wherein heat exchange is achieved between the partially contacting portions of the air compressor and liquid tank by conduction, raising the temperature of the internal wall of the liquid tank by conduction, and wherein heat exchange is then achieved between the internal wall of the liquid tank and the at least one fluid by way of convection, creating thermal communication between the pump and the at least one fluid, and wherein the compression motor is a brushless motor.

In a twelfth aspect of the present disclosure, which may be combined with any other aspect described herein, or portion thereof, the compression motor is configured to have an adjustable speed.

In a thirteenth aspect of the present disclosure, which may be combined with any other aspect described herein, or portion thereof, the compression motor is configured to have a variable flow rate.

In a fourteenth aspect of the present disclosure, which may be combined with any other aspect described herein, or portion thereof, a passenger car multi-system integration system comprises an air compressor comprising an air compressor exterior wall, and a pump, a first pressurized gas storage tank in pneumatic communication with the air compressor, a second pressurized gas storage tank in pneumatic communication with the air compressor, and a liquid tank comprising a liquid tank exterior wall that is configured to at least partially contact the air compressor exterior wall, an internal wall which forms a fluid vessel, and at least one fluid, wherein the air compressor and the liquid tank are configured such that when the pump operates, it expels energy in the form of heat as a byproduct, causing the air compressor exterior wall to rise in temperature, and wherein heat exchange is achieved between the partially contacting portions of the air compressor and liquid tank by conduction, raising the temperature of the internal wall of the liquid tank by conduction, and heat exchange is then achieved between the internal wall of the liquid tank and the at least one fluid by way of convection, creating thermal communication between the pump and the at least one fluid.

In a fifteenth aspect of the present disclosure, which may be combined with any other aspect described herein, or portion thereof, the first pressurized gas storage tank stores gas at a higher pressure than the second pressurized gas storage tank.

In a sixteenth aspect of the present disclosure, which may be combined with any other aspect described herein, or portion thereof, a passenger car multi-system integration system comprises an air compressor comprising an air compressor exterior wall, and a pump, a first pressurized gas storage tank in pneumatic communication with the air compressor, a second pressurized gas storage tank in pneumatic communication with the air compressor, a first pressure-regulating valve in pneumatic communication with at least one of the first and the second pressurized gas storage tank, a second pressure-regulating valve in pneumatic communication with at least one of the first and the second pressurized gas storage tank, and a liquid tank comprising a liquid tank exterior wall that is configured to at least a partially contact the air compressor exterior wall, an internal wall which forms a fluid vessel, and at least one fluid, wherein the air compressor and the liquid tank are configured such that when the pump operates, it expels energy in the form of heat as a byproduct, causing the air compressor exterior wall to rise in temperature, and wherein heat exchange is achieved between the partially contacting portions of the air compressor and liquid tank by conduction, raising the temperature of the internal wall of the liquid tank by conduction, and heat exchange is then achieved between the internal wall of the liquid tank and the at least one fluid by way of convection, creating thermal communication between the pump and the at least one fluid.

In a seventeenth aspect of the present disclosure, which may be combined with any other aspect described herein, or portion thereof, the first pressure-regulating valve allows gas to pass through at a higher pressure than does the second pressure-regulating valve.

Additional features and advantages of the disclosed system, method, and apparatus are described in, and are apparent from, the following Detailed Description and the Figures.

### BRIEF DESCRIPTION OF THE FIGURES

The accompanying drawings, which are incorporated in and constitute a part of this specification, show certain aspects of the subject matter disclosed herein and, together with the description, help explain some of the principles associated with the disclosed implementations.

FIG. 1 illustrates a first embodiment of a passenger car multi-system integration.

FIG. 2 illustrates a second embodiment of the passenger car multi-system integration.

FIG. 3 illustrates a third embodiment of the passenger car multi-system integration.

FIG. 4 illustrates a fourth embodiment of the passenger car multi-system integration.

FIGS. 5A-5C illustrate one example of the passenger car multi-system integration operating inside of a passenger vehicle.

FIGS. 6A-6C illustrate variations of the arrangement of the air compressor and liquid tank of the passenger car multi-system integration of FIG. 1.

FIG. 7 illustrates a fifth embodiment of the passenger car multi-system integration.

FIG. 8 illustrates a sixth embodiment of the passenger car multi-system integration.

### DETAILED DESCRIPTION

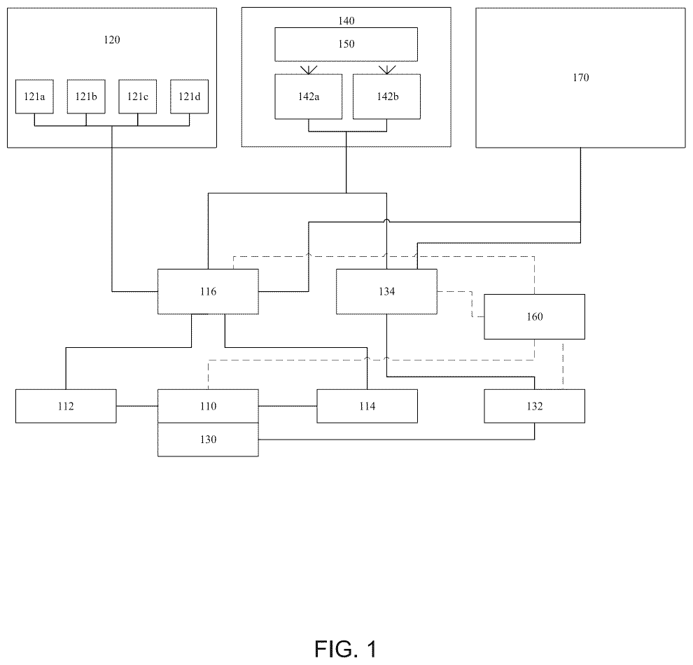

Referring now to the drawings and in particular to FIG. 1, an embodiment of a passenger car multi-system integration 100 is illustrated, and which includes an air compressor 110 and a liquid tank 130 positioned in thermal communication, such that heat transfer is facilitated between the air compressor 110 and the liquid tank 130. Thermal communication is achieved by, for example: (i) placing the air compressor 110 and the liquid tank 130 in close spatial proximity (in one embodiment, within 5 mm of each other); (ii) affixing the air compressor 110 to the liquid tank 130 by bolting the two components together such that there is no appreciable space between them; (iii) affixing the air compressor 110 to the liquid tank 130 by welding the two components together such that there is no appreciable space between them; (iv) manufacturing a combination part such that the air compressor 110 and the liquid tank 130 are a single piece of molded material; (v) encasing the air compressor 110 and the liquid tank 130 together in an insulting material such as silicone so that any heat generated by the air compressor 110 remains ambient to the liquid tank 130 with only minimal losses to the environment; or (vi) any other method of promoting heat transfer between the air compressor 110 and the liquid tank 130. A first pressurized gas storage tank 112 is in pneumatic communication with the air compressor 110 and a second pressurized gas storage tank 114 is also in pneumatic communication with the air compressor 110. Pneumatic communication can be achieved by affixing sealed tubes between two elements of the passenger car multi-system integration 100 or by any other method of transporting gases without loss to the environment. A controller 160 is in electronic communication with the air compressor 110 such that the controller 160 signals the air compressor 110 to fill the first pressurized gas storage tank 112 to a set pressure and also signals the air compressor 110 to fill the second pressurized gas storage tank 114 to a different set pressure. In some embodiments, the air compressor 110 is further equipped with a pressure relief valve. The pressure relief valve facilitates the start-up of the air compressor 110 in instances where the air compressor 110 is in a loaded or partially-loaded state before start-up, and the loading condition causes start-up to be difficult or in some instances to fail altogether. The pressure relief valve is employed in such circumstances to achieve zero-load or reduced-load start-up of the air compressor 110, which improves the start-up performance of the air compressor 110 and extends the serviceable life of the air compressor 110.

Both the first pressurized gas storage tank 112 and the second pressurized gas storage tank 114 are in pneumatic communication with at least one pneumatic solenoid valve 116, which facilitates the release of pressurized gas from either the first pressurized gas storage tank 112 or the second pressurized gas storage tank 114. The at least one pneumatic solenoid valve 116 in this manner acts as a gas distribution valve, allowing pressurized gas from one or both of the first pressurized gas storage tank 112 and the second pressurized gas storage tank 114 to be delivered to any of the gas systems in the passenger car multi-system integration 100. The differing pressure levels in the first pressurized gas storage tank 112 and the second pressurized gas storage tank 114 allows for gas under different storage pressures to be distributed to each of the different systems and equipment in order to meet a multitude of gas demands in the passenger car multi-system integration 100. The controller 160 is also in electronic communication with the at least one pneumatic solenoid valve 116 and signals the pneumatic solenoid valve 116 to release pressurized gas at the appropriate time. The released pressurized gas travels to either a pneumatic shock absorption system 120, a cleaning system 140, or at least one other gas and/or water supply system 170. The pneumatic shock absorption system 120 comprises at least one air spring 121a, but likely comprises four air springs 121a, 121b, 121c, 121d (one for each wheel on a standard passenger vehicle). The cleaning system 140 comprises at least one nozzle 142a, 142b that is positioned so as to facilitate the cleaning and/or defrosting/deicing of at least one electronic sensor 150. The other gas and/or water supply system 170 can be any system on a passenger vehicle which employs water or pressurized air to carry out its function. Examples of such systems include, but are by no means limited to, another pneumatic shock absorption system, another cleaning system, a seat massage system, or a seat ventilation system. The first pressurized gas storage tank 112 may, for example, service the pneumatic shock absorption system 120 at a pressure of 18 bar, while the second pressurized gas storage tank 114 may service a pneumatic seat ventilation system on the same passenger car at a pressure of 5 bar, while only using a single air compressor 110 to fill both the first and second pressurized gas storage tank 112, 114. Further, the at least one nozzle 142a, 142b may, in this arrangement, receive pressurized gas from either of the first pressurized gas storage tank 112 or the second pressurized gas storage tank 114, or both, independently. In this way, gas at different levels of pressure may be delivered to the at least one nozzle 142a, 142b depending on how much pressure is needed to be delivered to the at least one electronic sensor 150. The liquid tank 130 is in fluid communication with a water pump 132. The controller 160 is also in electronic communication with the water pump 132 such that the controller 160 signals the water pump 132 to pump water from the liquid tank 130 through a waterway solenoid valve 134, which facilitates the release of water from the liquid tank 130. The controller 160 is also in electronic communication with the waterway solenoid valve 134 and signals the waterway solenoid valve 134 to release water at the appropriate time. The released water travels to either the cleaning system 140 or the other gas and/or water supply system 170.

Although the term “liquid tank” is used to describe the liquid tank 130, it should be understood that any liquid or liquid solution may be employed as desired. For example, water, windshield wiper fluid, or another cleaning solution may be used in the liquid tank 130.

The thermal communication between the air compressor 110 and the liquid tank 130 allows any thermal exhaust from the air compressor 110 to be translated to the liquid tank 130, effectively heating up water in the liquid tank 130 without the need for another heating element to heat that water. The heated water can then be sent to the nozzle 142a, 142b and sprayed onto the electronic sensor 150 so that dirt or debris from the environment which is inhibiting the proper functioning of the electronic sensor 150 is cleared away, or so that the electronic sensor 150 can be defrosted/deiced. The use of this thermal communication removes or reduces the reliance on a heating element for the liquid tank 130, especially in cold climates where the water in the tank may freeze and clog the hydraulic systems in the passenger vehicle, while also efficiently repurposing any thermal exhaust which is a byproduct of the operation of the air compressor 110 and would otherwise be lost to the environment. The liquid in the liquid tank 130 may also constitute any liquid that is desirable for the purposes of the different passenger car systems, and the use of the term liquid tank 130 is not intended to limit the fluid that may be used. For example, windshield wiper fluid may be employed as the liquid in the liquid tank 130.

The air compressor 110 also creates heated air when it compresses air because the operation of the air compressor 110 raises the ambient temperature surrounding and inside the air compressor 110. This heated air can be sent to a nozzle 142a, 142b and sprayed onto the electronic sensor 150 so that dirt or debris from the environment which is inhibiting the proper functioning of the electronic sensor 150 is cleared away, or so that the electronic sensor 150 can be defrosted/deiced. This efficiently uses the heat created by the air compressor 110 in the compressing process and removes or reduces the reliance on a heating element for the gas in the air compressor 110, especially in cold climates where a heating element would have to be employed and use more energy to produce the desired effect than it otherwise would have in the present embodiment.

It should be noted that the air compressor 110 need not be in thermal communication with the liquid tank 130 in order to gain the advantages of having the first pressurized gas storage tank 112 at a different pressure than the second pressurized gas storage tank 114, and there need not be a second pressurized gas storage tank 114 in order to gain the advantages of having the air compressor 110 be in thermal communication with the liquid tank 130. It should also be noted that each electronic sensor 150 may have any number of associated nozzles, depending on the desired configuration.

Reference may be made in the below descriptions of the figures to components with the same reference numerals as other embodiments. Unless otherwise notes, components that share reference numerals are intended to denote the same or equivalent components with similar features and advantages as apparent to those skilled in the art.

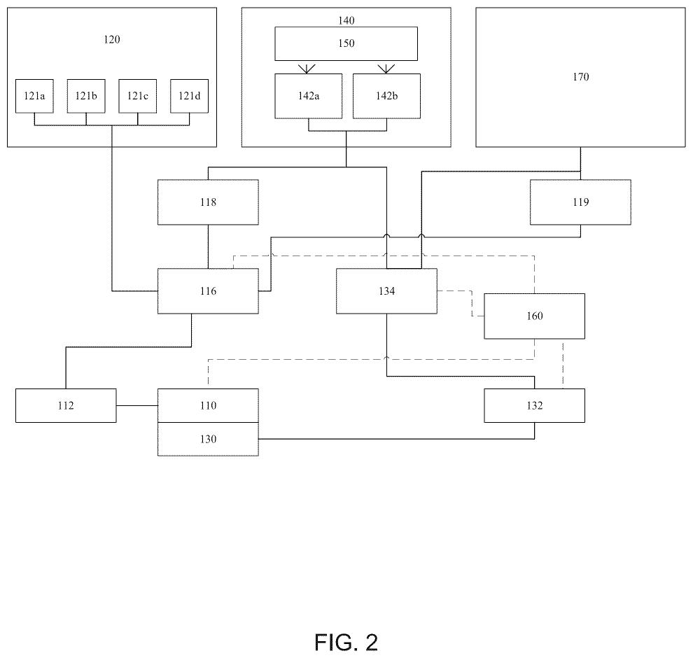

Referring now in particular to FIG. 2, a different embodiment of a passenger car multi-system integration 100 is illustrated, which includes a first pressure-regulating valve 118 in pneumatic communication with a pneumatic solenoid valve 116 and a cleaning system 140, and a second pressure-regulating valve 119 in pneumatic communication with the pneumatic solenoid valve 116 and at least one other gas and/or water supply system 170. The first pressure-regulating valve 118 only allows gas with a certain maximum pressure to be released to the cleaning system 140. The second pressure-regulating valve 119 only allows gas with a certain maximum pressure which is different than the maximum pressure allowed by the first pressure-regulating valve 118 to be released to the other gas and/or water supply system 170. This allows multiple pressures to be achieved in different pneumatic-dependent systems using only a single pressurized gas storage tank 112, rather than employing at least a second pressurized gas storage tank 114 (such as the embodiment in FIG. 1 describes). The first pressure-regulating valve 118 may, for example, service the pneumatic shock absorption system 120 by allowing only air at a pressure of 18 bar to flow to that system from the pressurized gas storage tank 112, while the second pressure-regulating valve 119 may service a pneumatic seat ventilation system on the same passenger car by allowing only air at a pressure of 5 bar to flow to that system, while only using a single pressurized gas storage tank 112. This reduces the amount of gas storage tanks needed, which in turn reduces the amount of material needed in the passenger car multi-system integration 100. Further, this reduces manufacturing costs and the weight of the passenger vehicle. It should also be appreciated that more than one pressurized gas storage tank (such as in the embodiment in FIG. 1) could still be employed in combination with the multiple pressure-regulating valves of the current embodiment of FIG. 2. It should be noted that the air compressor 110 need not be in thermal communication with the liquid tank 130 in order to gain the advantages of having a first pressure-regulating valve 118 which operates at a different maximum pressure than a second pressure-regulating valve 119. However, in the embodiment of FIG. 2, the advantages of having the air compressor 110 in thermal communication with the liquid tank 130 enumerated in the description of FIG. 1 are also present in the embodiment of FIG. 2.

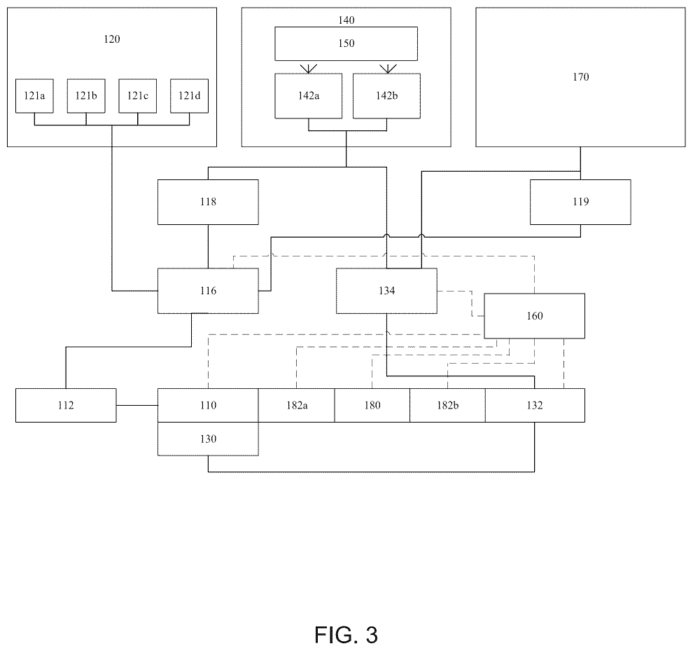

Referring now in particular to FIG. 3, a different embodiment of a passenger car multi-system integration 100 is illustrated, which includes a motor 180 mechanically coupled to at least a first electromagnetic clutch 182a and a second electromagnetic clutch 182b. The first electromagnetic clutch 182a is in turn mechanically coupled to an air compressor 110. The second electromagnetic clutch 182b is in turn mechanically coupled to a water pump 132. The controller 160 is in electronic communication with the first electromagnetic clutch 182a and the second electromagnetic clutch 182b, and can signal for each to independently engage the energy from the motor 180 to translate to the air compressor 110 and the water pump 132, respectively. Therefore, a single motor 180 can be used to independently run both the air compressor 110 and the water pump 132. This embodiment allows the use of a single motor 180 where other cars would need one motor 180 for each of the air compressor 110 and the water pump 132 in order to run each component. This reduces the manufacturing cost for the passenger vehicle and also reduces the weight of the passenger vehicle. It should be noted that the air compressor 110 need not be in thermal communication with the liquid tank 130 in order to gain the advantages of having a motor 180 mechanically coupled to at least a first electromagnetic clutch 182a and a second electromagnetic clutch 182b, wherein the first electromagnetic clutch 182a is mechanically coupled to the air compressor 110 and the second electromagnetic clutch 182b is mechanically coupled to the water pump 132.

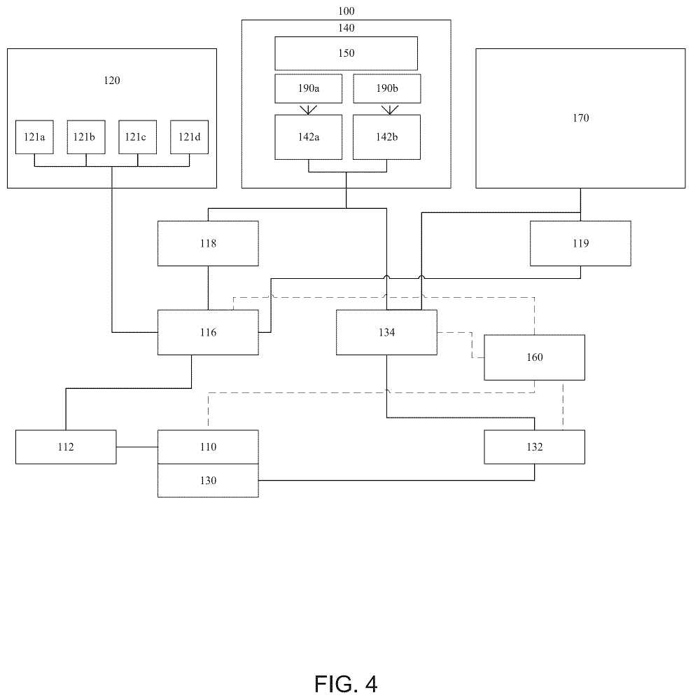

Referring now in particular to FIG. 4, a different embodiment of a passenger car multi-system integration 100 is illustrated, wherein at least a first resistance wire 190a is placed between the first nozzle 142a and the electronic sensor 150 and a second resistance wire 190b is placed between the second nozzle 142b and the electronic sensor 150. Each resistance wire 190a, 190b is configured to provide a heat source such that any gas or liquid leaving one of the nozzles 142a, 142b is heated by the resistance wire on its way to the electronic sensor 150. The resistance wire 190a, 190b can be directly powered by the passenger vehicle's battery or the engine power supply, and can also be controlled by the controller 160 such that the controller 160 signals for the resistance wire 190a, 190b to heat up when the electronic sensor 150 becomes dirty or has frost/ice buildup. This provides an alternative or supplementary source of heat for the gas or liquid cleaning agent as it reaches the electronic sensor 150. Alternatively, the first resistance wire 190a or the second resistance wire 190b could be configured to sit in close proximity of the electronic sensor 150 so as to provide direct heat to the surface of the electronic sensor 150. Also alternatively, the first resistance wire 190a or second resistance wire 190b could be a chip resistor, such as to form a geometry with a greater surface area for better distribution of heat to the gas or liquid cleaning agent or directly to the electronic sensor 150 depending upon the desired configuration. It should be noted that the air compressor 110 need not be in thermal communication with the liquid tank 130 in order to gain the advantages of having at least a first resistance wire 190a or a second resistance wire 190b. It should also be noted that each nozzle 142a, 142b may have more than one associated resistance wire 190a, 190b or none at all, depending on the desired configuration.

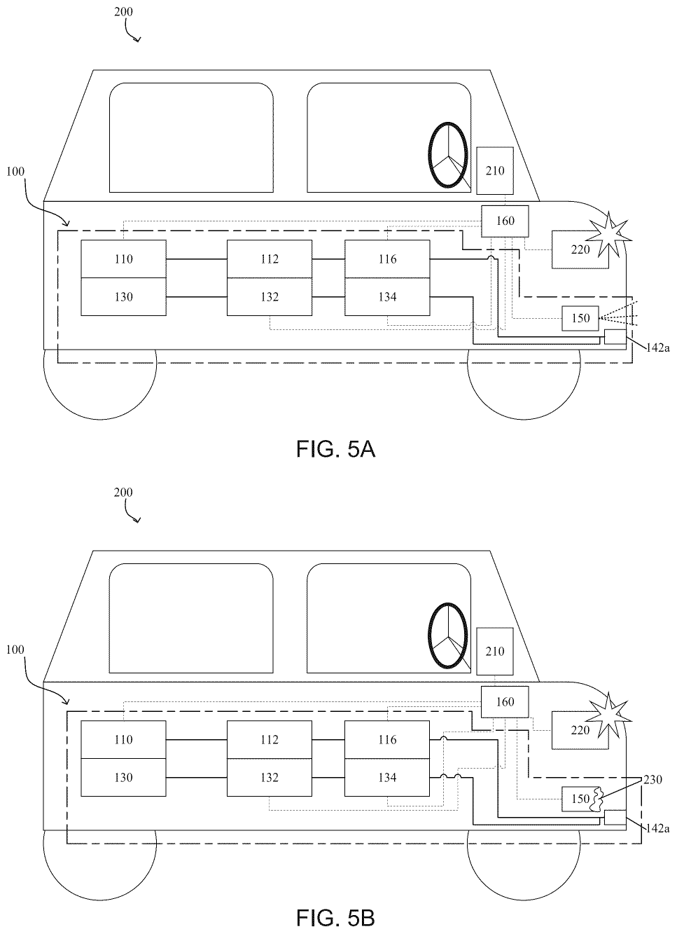

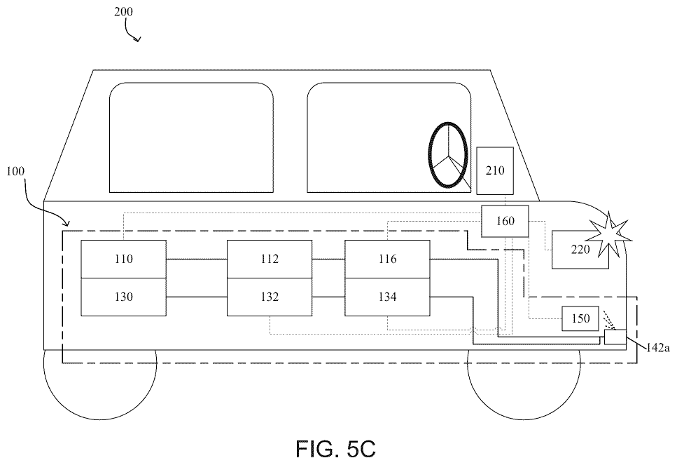

Referring now to FIGS. 5A-5C, one example of a passenger car multi-system integration 100 inside of a passenger car 200 is illustrated to demonstrate how one function of the passenger car multi-system integration 100 could operate. The passenger car 200 has a dashboard display 210 which a driver or passenger can use to perform a variety of functions (such as turn a radio on and off, adjust climate settings, check the level of the gas tank, etc.) and at least one headlight 220 which in this embodiment is turned on. The passenger car 200 also includes the passenger car multi-system integration 100 in an embodiment in which the air compressor 110 and the liquid tank 130 are in thermal communication as described in previous embodiments. In the present embodiment, the pressurized gas storage tank 112 containing warmed air from the air compressor 110 is also in thermal communication with the water pump 132, such that the operation of the water pump 132 continues to keep the gas in the pressurized gas storage tank 112 at a temperature above the environment or continues to warm the gas in the pressurized gas storage tank 112 even further. The thermal communication between the pressurized gas storage tank 112 and the water pump 132 can be achieved by the same or similar means as those described in FIG. 1 between the air compressor 110 and the liquid tank 130. The pneumatic solenoid valve 116 and the waterway solenoid valve 134 are also in thermal communication in this embodiment in order to help reduce temperature losses as the gases and liquids in the passenger car multi-system integration 100 travel from one location to the next. By keeping the heated gases and liquids in close proximity, the ambient temperature near the gases and the liquids is raised and heat transfer with the environment occurs at a slower rate. This is also true for the lines that the gases and liquids move through in the passenger car multi-system integration 100. For instance, if warmed water is traveling through the passenger car multi-system integration 100 from the liquid tank 130 to a nozzle 142a, while warmed air is traveling through the passenger car multi-system integration 100 from the pressurized gas storage tank 112 to a nozzle 142a (or any other part of the passenger car multi-system integration 100), then having the exterior of the two lines that the warmed water and the warmed air travel through be in contact with each other will create at least a partial surface area on each line that is warmer than the ambient temperature and will promote the retention of heat in each line by having less surface area of each line that is losing heat to the ambient air by convection. Even if the two lines are not in contact but only close together (for example, separated by 3 mm), the ambient air may be heated by each line such that the ambient air on at least part of the surface area of each line is warmer than the other ambient air from the environment and will slow down the process of losing heat to the ambient air by way of convection. The passenger car 200 also has an electronic sensor 150 which in this embodiment aids in the performance of adaptive cruise control. The electronic sensor 150 here sends out a signal to the environment and if any signal is returned the electronic sensor 150 communicates this information to the controller 160 which in turn causes the car to slow down if the cruise control is engaged. The air compressor 110, water pump 132, pneumatic solenoid valve 116, waterway solenoid valve 134, dashboard display 210, headlight 220, and electronic sensor 150 are all in electronic communication with the controller 160. The passenger car multi-system integration 100 also includes at least one nozzle 142a which in this embodiment is configured so that gases and liquids which are expelled from the nozzle 142a come in contact with the part of the electronic sensor 150 which sends out and receives a signal.

FIG. 5A demonstrates a normally operating passenger car 200, including a normally operating electronic sensor 150. FIG. 5B demonstrates a passenger car 200 with a malfunctioning electronic sensor 150 due to a build-up of grime 230 on the part of the electronic sensor 150 which sends and receives a signal. This grime 230 may be dirt from the road, mud from the road, water build-up on a rainy day, snow caked onto the sensor's exterior, ice or frost buildup, grease from another part of the passenger car 200, or any other foreign object or substance which appends itself to the electronic sensor 150. This grime 230 can cause the signal sending or receiving portions of the electronic sensor 150 to malfunction, which can cause frustration to the operator of the passenger car 200 or be dangerous if, for example, the passenger car 200 does not slow down when approaching vehicles or objects while using the cruise control feature. FIG. 5C demonstrates gas or liquid from the pressurized gas storage tank 112 or liquid tank 130 being expelled from the nozzle 142a and contacting the surface of the electronic sensor 150 in order to remove the grime 230. Once this is achieved the passenger car 200 resumes the state of the embodiment in FIG. 5A.

The controller 160 can be a shared control unit for the passenger car 200, which controls the operations of any electronic component of the car (such as a radio or climate control) or any microcontroller or microprocessor. For example, the controller 160 could be located in a passenger's cell phone and communicate by wireless communication technology about the status of the passenger car multi-system integration 100 and communicate with any actuators or other controllers that the passenger car 200 is configured to have based upon desire, which would allow for a notification to be sent to the passenger's cellphone for the passenger to decide whether to activate certain features of the passenger car multi-system integration 100. Further controllers 160 could be placed on each component of the passenger car multi-system integration 100 such that a network of controllers operate in tandem to facilitate which elements operate at a given time, relay the temperature of each element, relay the status of each element as operating properly or malfunctioning, facilitate the operation of any actuators, or any other desired function. The purpose of the controller 160 is to facilitate the actuation of a system of the passenger car 200 or passenger car multi-system integration 100 based upon the desire of the user (for example, if a user is too warm in the cabin of the passenger car 200, the user may direct the controller to lower the temperature of a climate control system) or to automatically engage countermeasures when a system malfunctions (such as receiving information that an adaptive cruise control system is malfunctioning and automatically engaging a cleaning system to remove grime 230 from the sensor of the adaptive cruise control system).

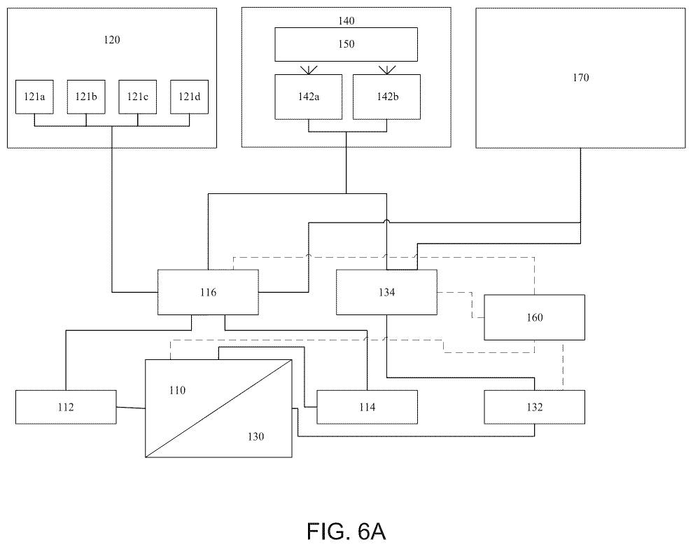

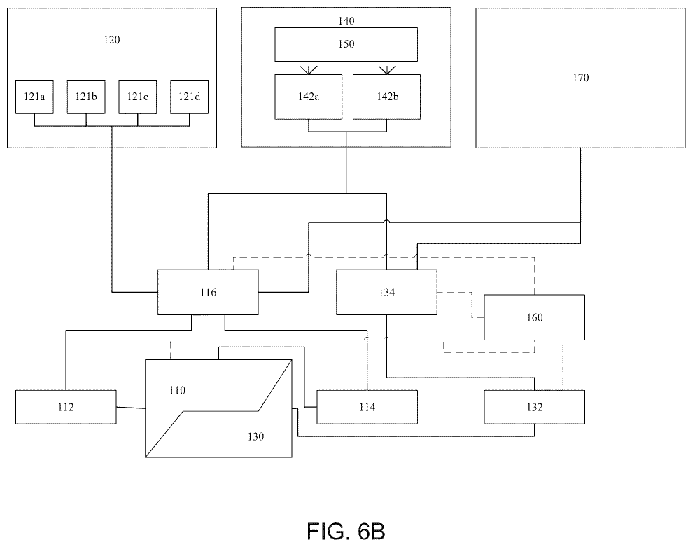

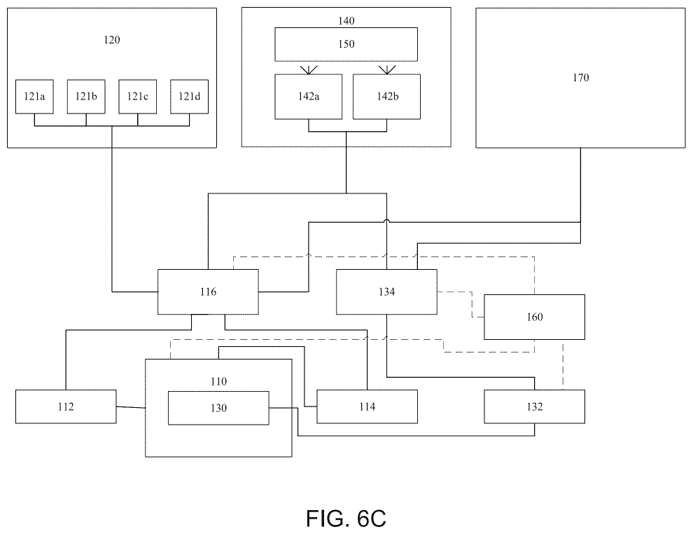

Referring now to FIGS. 6A-6C, the passenger car multi-system integration 100 of FIG. 1 is illustrated with variations of the arrangement and/or position of the air compressor 110 and the liquid tank 130. Each of the arrangements of FIGS. 6A-6C is intended to increase the surface area contact between the air compressor 110 and the liquid tank 130 to promote greater heat transfer from the air compressor 110 to the liquid tank 130, which in turn reduces further the amount of energy lost to the environment. For example, in FIG. 6A, the air compressor 110 and liquid tank 130 comprise right triangle profiles, with the hypotenuse of each right triangle in contact with the other, creating the greatest possible amount of contact between two sides of the geometries. In the arrangement of FIG. 6B, a more complex polygonal profile is provided for the air compressor 110 and liquid tank 130, which creates an even greater surface area of contact between the air compressor 110 and the liquid tank 130 than the arrangement of FIG. 6A. It should be appreciated that the air compressor 110 and the liquid tank 130 may have any desirable polygonal profile geometry in order to maximize the contact surface area between the air compressor 110 and the liquid tank 130. For example, the air compressor 110 and liquid tank 130 may have a nesting (i.e. inverse) sawtooth profile geometry. In the arrangement of FIG. 6C, the liquid tank 130 is substantially entirely nested within the air compressor 110 in order to promote the maximum possible heat transfer from the air compressor 110 to the liquid tank 130. It should be appreciated that variations of the profile geometries and arrangements may be combined, such that the contact area between the air compressor 110 and the liquid tank 130 may be a complex polygonal profile while also having the liquid tank 130 nested within the air compressor 110. In this way the contact surface area compared to the volume of each of the air compressor 110 and liquid tank 130 may be maximized.

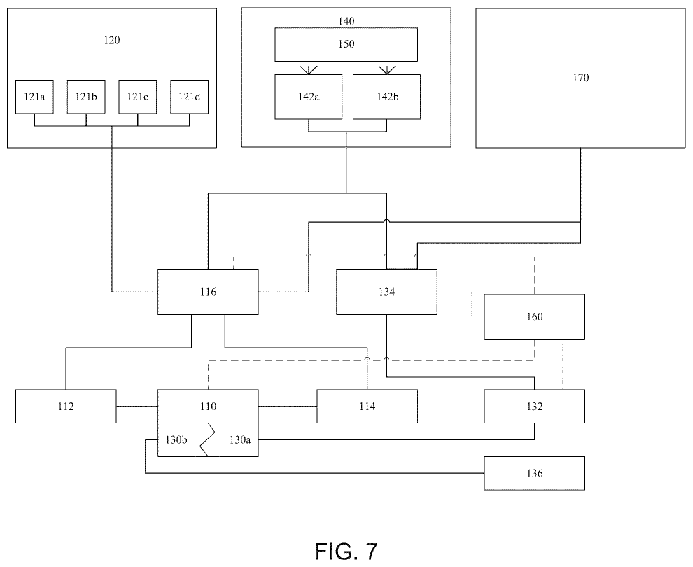

Turning now to FIG. 7, an alternative embodiment of the passenger car multi-system integration 100 is illustrated. In this embodiment, the liquid tank 130 has been divided into a first liquid tank 130a and a second liquid tank 130b. The first liquid tank 130a may be configured to house water, windshield wiper fluid, cleaning solution, or any other appropriate fluid or fluids as described above. The second liquid tank 130b may be a braking fluid reservoir that provides braking fluid to a hydraulic braking system 136. It should be appreciated that the air compressor 110, first liquid tank 130a, and second liquid tank 130b may be arranged in any of the arrangements described in the above embodiments to provide the desired level of thermal communication between each of the air compressor 110, first liquid tank 130a, and second liquid tank 130b. Furthermore, the first liquid tank 130a and second liquid tank 130b need not have the same amount of thermal communication with the air compressor 110. For example, it may be preferable to have greater thermal communication between the air compressor 110 and the first liquid tank 130a than between the air compressor 110 and the second liquid tank 130b if the liquid in the first liquid tank 130a benefits from more heat transfer from the air compressor 110 than does the second liquid tank 130b. Different levels of thermal communication may be achieved, for example, by having a greater surface area contact between the air compressor 110 and the first liquid tank 130a than the contact surface area between the air compressor 110 and the second liquid tank 130b. Different configurations of surface area contact may be achieved by adjusting the geometry of the first liquid tank 130a and/or the second liquid tank 130b or by adjusting the spatial arrangement of the air compressor 110, the first liquid tank 130a, and/or the second liquid tank 130b.

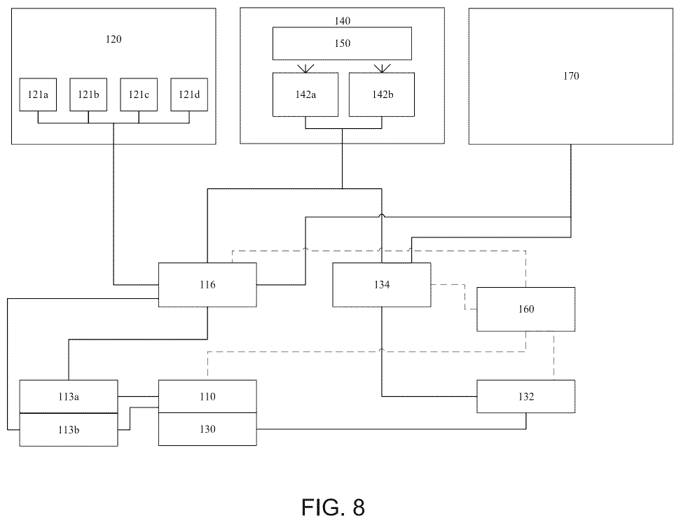

Referring now to FIG. 8, another alternative embodiment of the passenger car multi-system integration 100 is illustrated. In this embodiment, the first pressurized gas storage tank 112 and the second pressurized gas storage tank 114 are integrated into a single pressurized gas tank 113, with the interior of the tank divided into a first gas storage chamber 113a and a second gas storage chamber 113b. This configuration allows the passenger car multi-system integration to be used for car air suspension systems that are equipped with multiple single chamber air storage tanks. The configuration of FIG. 8 allows cars with such a suspension system to utilize space effectively by integrating the multiple gas storage tanks 113a,b into a single pressurized gas tank 113, which further reduces manufacturing costs and provides independent, stable gas sources for multiple systems in a minimal space.

### Conclusion

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of these terms also does not exclude the possibility of other unrecited features or elements and is merely meant to be illustrative, unless otherwise implicitly or explicitly contradicted by the context in which it used.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above.

The invention is claimed as follows:

1. A passenger car multi-system integration system comprising:
an air compressor comprising:
an air compressor exterior wall; and
a pump; and
a liquid tank comprising:
a liquid tank exterior wall that is configured to at least a partially contact the air compressor exterior wall;
an internal wall which forms a fluid vessel; and
at least one fluid,
wherein the air compressor and the liquid tank are configured such that when the pump operates, it expels energy in the form of heat as a byproduct, causing the air compressor exterior wall to rise in temperature, and
wherein heat exchange is achieved between the partially contacting portions of the air compressor and liquid tank by conduction, raising the temperature of the internal wall of the liquid tank by conduction, and wherein heat exchange is then achieved between the internal wall of the liquid tank and the at least one fluid by way of convection, creating thermal communication between the pump and the at least one fluid.

2. The passenger car multi-system integration system of claim 1, further comprising:
an electronic sensor; and
a cleaning system comprising:
at least one nozzle in pneumatic communication with the air compressor or in hydraulic communication with the liquid tank, the at least one nozzle configured such that the expulsion of gas or liquid from the nozzle causes contact between the gas or liquid and the electronic sensor.

3. The passenger car multi-system integration system of claim 2, wherein gas which has been heated by the operation of the air compressor is expelled from the nozzle.

4. The passenger car multi-system integration system of claim 2, wherein liquid which has been heated by the operation of the air compressor in thermal communication with the liquid tank is expelled from the nozzle.

5. The passenger car multi-system integration system of claim 2, further comprising:
a resistance wire.

6. The passenger car multi-system integration system of claim 5, wherein the resistance wire is a chip resistor.

7. The passenger car multi-system integration system of claim 5, wherein the resistance wire is configured between the nozzle and the electronic sensor such that any gas or liquid expelled from the nozzle comes in contact with the resistance wire.

8. The passenger car multi-system integration system of claim 5, wherein the resistance wire is in thermal communication with the electronic sensor.

9. A passenger car multi-system integration system comprising:
an air compressor;
a liquid tank;
a water pump in hydraulic communication with the liquid tank;
a motor;
a first electromagnetic clutch which is in mechanical communication with the motor and the air compressor; and
a second electromagnetic clutch which is in mechanical communication with the motor and the water pump.

10. The passenger car multi-system integration system of claim 9, wherein the first electromagnetic clutch is able to engage independently of the second electromagnetic clutch and the second electromagnetic clutch is able to engage independently of the first electromagnetic clutch, such that power is able to be independently translated from the motor to either the air compressor or the water pump, or both.

11. A passenger car multi-system integration system comprising:
an air compressor comprising:
an air compressor exterior wall;
a compression motor; and
a pump; and
a liquid tank comprising:
a liquid tank exterior wall that is configured to at least a partially contact the air compressor exterior wall;
an internal wall which forms a fluid vessel; and
at least one fluid,
wherein the air compressor and the liquid tank are configured such that when the pump operates, it expels energy in the form of heat as a byproduct, causing the air compressor exterior wall to rise in temperature,
wherein heat exchange is achieved between the partially contacting portions of the air compressor and liquid tank by conduction, raising the temperature of the internal wall of the liquid tank by conduction, and wherein heat exchange is then achieved between the internal wall of the liquid tank and the at least one fluid by way of convection, creating thermal communication between the pump and the at least one fluid, and
wherein the compression motor is a brushless motor.

12. The passenger car multi-system integration of claim 11, wherein the compression motor is configured to have an adjustable speed.

13. The passenger car multi-system integration of claim 11, wherein the compression motor is configured to have a variable flow rate.

14. A passenger car multi-system integration system comprising:
an air compressor comprising:
an air compressor exterior wall; and
a pump;
a first pressurized gas storage tank in pneumatic communication with the air compressor;
a second pressurized gas storage tank in pneumatic communication with the air compressor; and
a liquid tank comprising:
a liquid tank exterior wall that is configured to at least partially contact the air compressor exterior wall;
an internal wall which forms a fluid vessel; and
at least one fluid;
wherein the air compressor and the liquid tank are configured such that when the pump operates, it expels energy in the form of heat as a byproduct, causing the air compressor exterior wall to rise in temperature, and
wherein heat exchange is achieved between the partially contacting portions of the air compressor and liquid tank by conduction, raising the temperature of the internal wall of the liquid tank by conduction, and heat exchange is then achieved between the internal wall of the liquid tank and the at least one fluid by way of convection, creating thermal communication between the pump and the at least one fluid.

15. The passenger car multi-system integration system of claim 14, wherein the first pressurized gas storage tank stores gas at a higher pressure than the second pressurized gas storage tank.

16. A passenger car multi-system integration system comprising:
an air compressor comprising:
an air compressor exterior wall; and
a pump;
a first pressurized gas storage tank in pneumatic communication with the air compressor;
a second pressurized gas storage tank in pneumatic communication with the air compressor;
a first pressure-regulating valve in pneumatic communication with at least one of the first and the second pressurized gas storage tank;
a second pressure-regulating valve in pneumatic communication with at least one of the first and the second pressurized gas storage tank; and
a liquid tank comprising:
a liquid tank exterior wall that is configured to at least a partially contact the air compressor exterior wall;
an internal wall which forms a fluid vessel; and
at least one fluid,
wherein the air compressor and the liquid tank are configured such that when the pump operates, it expels energy in the form of heat as a byproduct, causing the air compressor exterior wall to rise in temperature, and
wherein heat exchange is achieved between the partially contacting portions of the air compressor and liquid tank by conduction, raising the temperature of the internal wall of the liquid tank by conduction, and heat exchange is then achieved between the internal wall of the liquid tank and the at least one fluid by way of convection, creating thermal communication between the pump and the at least one fluid.

17. The passenger car multi-system integration system of claim 16, wherein the first pressure-regulating valve allows gas to pass through at a higher pressure than does the second pressure-regulating valve.
